(19) United States
(12) Patent Application Publication
(10) Pub. No.: US 2019/0270344 A1
(43) Pub. Date: Sep. 5, 2019

(54) HEAVY LOAD TIRE

(71) Applicant: BRIDGESTONE CORPORATION, Tokyo (JP)

(72) Inventor: Tomoo HASEGAWA, Tachikawa-shi (JP)

(73) Assignee: BRIDGESTONE CORPORATION, Tokyo (JP)

(21) Appl. No.: 16/303,103

(22) PCT Filed: May 26, 2017
(86) PCT No.: PCT/JP2017/019797

§ 371 Date: Nov. 19, 2018

(30) Foreign Application Priority Data
May 27, 2016 (JP) 2016-106223

(51) Int. Cl. B60C 11/03; B60C 9/20

(52) U.S. Cl. CPC B60C 11/0309; B60C 11/0302; B60C 11/0311; B60C 9/2006; B60C 2011/0372; B60C 2011/0355; B60C 2011/0344; B60C 2011/0365; B60C 2011/0313

(57) ABSTRACT

A heavy load tire includes a first inner widthwise groove which opens to a circumferential groove and which is arranged in the tire circumferential direction on at least one side of a tread portion. The first inner widthwise groove is provided with a widthwise linear groove that linearly extends from the circumferential groove in the tire widthwise direction, and a curved groove which connects to the inner end in the tire widthwise direction of the widthwise linear groove, extends inward in the tire widthwise direction, extends in the tire normal rotation direction, and reaches the tire equator line. In addition, the angle formed between the curved groove and the tire widthwise direction becomes smaller in a direction toward the tire equator line.

### TECHNICAL FIELD

The present invention relates to a heavy load tire provided with a tread portion.

### RELATED ART

A heavy load tire such as a construction vehicle tire is generally provided with a carcass ply, a belt layer, and a tread portion in order. In addition, the belt layer is usually composed of a plurality of belts, and Patent Literature 1 discloses a heavy load tire having: a protective belt layer composed of two protective belts, that is, a protective crossing belt layer, a main crossing belt layer composed of two main crossing belts; and a small crossing belt layer composed of two small crossing belts.

In such a tire, the main crossing belt layer is arranged on an outer side in a tire radial direction than the small crossing belt layer, and the protective belt layer is arranged on an outer side in the tire radial direction than the main crossing belt layer.

The angle formed by a tire circumferential direction and a cord constituting the small crossing belt layer is, for example, 4 to 10°, the angle formed by the tire circumferential direction and a cord constituting the main crossing belt layer is, for example, 18 to 35°, and the angle formed by the tire circumferential direction and a cord constituting the protective belt layer is, for example, 22 to 33°.

### CITATION LIST

### Patent Literature

### Patent Literature 1: WO 2013/157544

### SUMMARY OF INVENTION

### Technical Problem

When arranging a high angle belt having a small angle such as 4 to 10° between a belt cord and the tire circumferential direction, growth of a tire part due to the internal pressure or running, that is, increase in the tire diameter is suppressed.

As a result, increase in the tire diameter due to the internal pressure or running occurs at an outer part in a tire widthwise direction of the high angle belt, especially at a ¼ point which is a position spaced from the tire equator line by ¼ of the width in the tire widthwise direction of the tread portion. In addition, circumferential driving force is generated at a tire part where the tire diameter is increased, while braking force is generated on the contrary at a tire part where the tire diameter is hardly increased, and a difference in the degree of deformation between both the tire parts generates shearing force, which is likely to cause uneven wear.

It is to be noted that such a phenomenon is not limited to a case where a high angle belt is arranged in the belt layer but also occurs in a case where a rolling radius is comparatively different in the same tire. For example, the tire diameter and the rolling radius in the vicinity of the tire equator line become larger than those in the vicinity of end portions in the tire widthwise direction. Therefore, when such a tire rotates, force in a tire rotation direction, that is, driving force is generated in a center region, which is a region in the vicinity of the tire equator line, and force in a direction opposite to the tire rotation direction, that is, braking force is generated in a shoulder region, which is a region in the vicinity of the end portions in the tire widthwise direction, and therefore shearing force is generated in the vicinity of the boundary between both the regions, causing uneven wear.

In addition, these are remarkable especially in large construction vehicle tires among heavy load tires.

The present invention has been made in view of the above-described problems, and it is an object of the present invention to provide a heavy load tire capable of improving uneven wear resistance property by suppressing shearing force to be generated between a tread rubber part where driving force is generated and a tread rubber part adjacent to the above-described tread rubber part where braking force is generated.

### Solution to Problem

A heavy load tire according to first aspect of the present invention includes a tread portion. The tread portion is partitioned into a plurality of portions by a widthwise groove extending in a tire widthwise direction, and at least one of a circumferential groove extending in a tire circumferential direction and a tread end that is an end portion of the tread portion. The circumferential groove and a first inner widthwise groove, which is arrayed in a tire circumferential direction and included in the widthwise groove, are formed on at least one side of a tire equator line. The first inner widthwise groove opens to the circumferential groove, extends inward in the tire widthwise direction, and reaches the tire equator line. The first inner widthwise groove includes an inner widthwise linear groove extending linearly along a tire widthwise direction from the circumferential groove toward an inner side in the tire widthwise direction, and a curved groove, which is continuous with an inner end in the tire widthwise direction of the inner widthwise linear groove, extends inward in the tire widthwise direction and in a tire normal rotation direction, and reaches the tire equator line. An angle formed by the curved groove and the tire widthwise direction becomes smaller toward the tire equator line.

A heavy load tire according to second aspect of the present invention includes a tread portion. The tread portion is partitioned into a plurality of portions by a widthwise groove extending in a tire widthwise direction, and at least one of a circumferential groove extending in a tire circumferential direction and a tread end that is an end portion of the tread portion. The widthwise groove has an inflection point where a direction of a convex or a concave with respect to the tire circumferential direction changes on at least one side of a tire equator line. The widthwise groove extends with an angle against the tire widthwise direction becoming smaller toward the tire equator line and reaches the tire equator line on an inner side in the tire widthwise direction than the inflection point. The widthwise groove extends toward a side opposite to a tire normal rotation direction and outward in the tire widthwise direction and further extends in the tire normal rotation direction and outward in the tire widthwise direction on an outer side in the tire widthwise direction than the inflection point so as to have a curved convex shape toward a side opposite to the tire normal rotation direction.

### Advantageous Effects of Invention

A heavy load tire according to the aspects of the present invention improves uneven wear resistance property by suppressing shearing force to be generated between a tread rubber part where driving force is generated and a tread rubber part adjacent to the above-described tread rubber part where braking force is generated.

### BRIEF DESCRIPTION OF DRAWINGS

FIG. 1 is a sectional view of a construction vehicle tire according to the first embodiment in a tire widthwise direction along a tire radial direction.

FIG. 2 is an explanatory drawing for explaining the belt structure of the construction vehicle tire according to the first embodiment.

FIG. 3 is a plan view for explaining a tread pattern in the construction vehicle tire according to the first embodiment.

FIG. 4 is a sectional view of a first inner widthwise groove formed at a tread portion of the construction vehicle tire according to the first embodiment.

FIG. 5 is a sectional view of a construction vehicle tire according to the second embodiment in a tire widthwise direction along a tire radial direction.

FIG. 6 is an explanatory drawing for explaining the belt structure of the construction vehicle tire according to the second embodiment.

FIG. 7 is a plan view for explaining a tread pattern in the construction vehicle tire according to the second embodiment.

FIG. 8 is a sectional view of a first inner widthwise groove formed at a tread portion of the construction vehicle tire according to the second embodiment.

FIG. 9 is a plan view for explaining a variation of a tread pattern in the construction vehicle tire according to the second embodiment.

### DESCRIPTION OF EMBODIMENTS

The following description will explain some embodiments of the present invention with reference to the attached drawings using a construction vehicle tire as an example of a heavy load tire. In the following description, the same or similar parts are denoted by the same or similar reference numerals, and detailed description thereof is appropriately omitted. Moreover, the following embodiments are illustrations for embodying the technical idea of the present invention, and embodiments of the present invention can be implemented with various modifications without departing from the gist.

### First Embodiment

First, the first embodiment will be described.

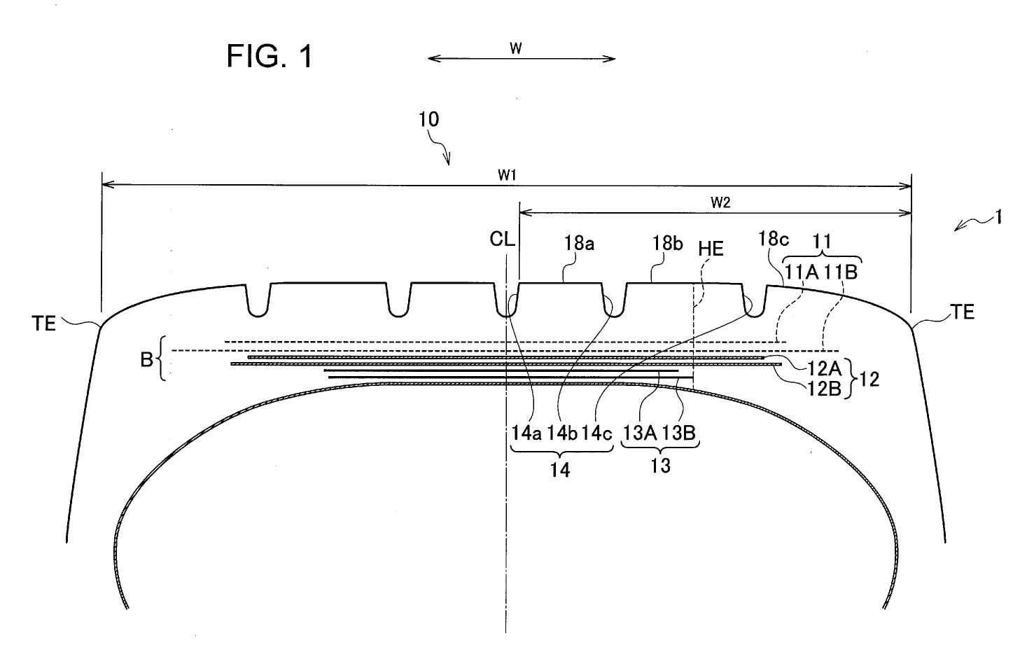

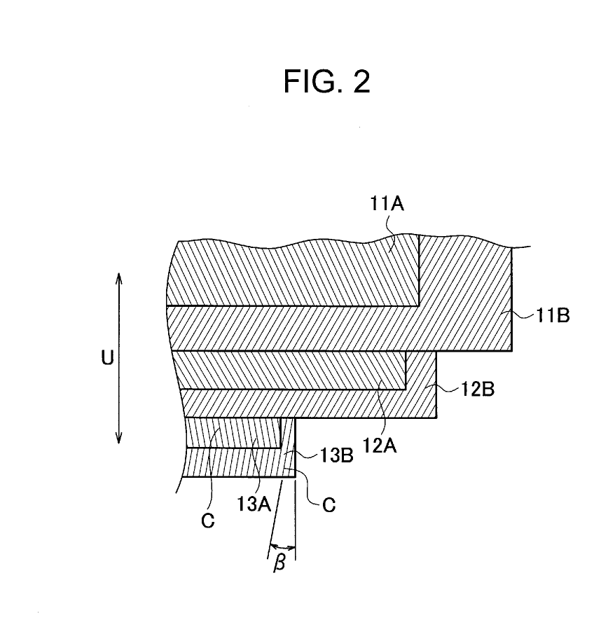

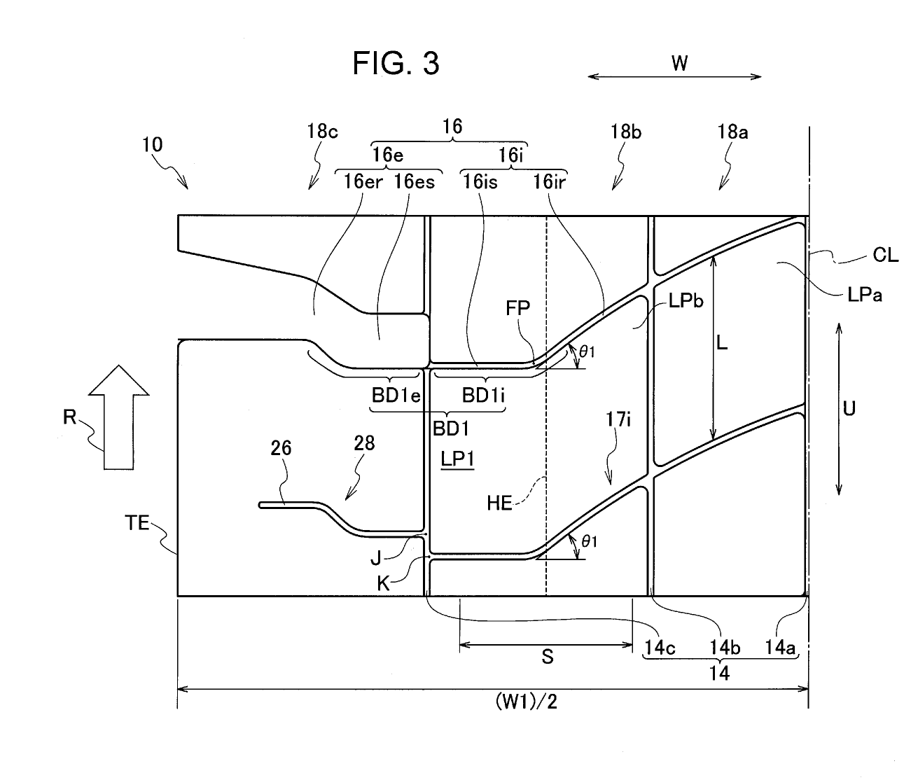

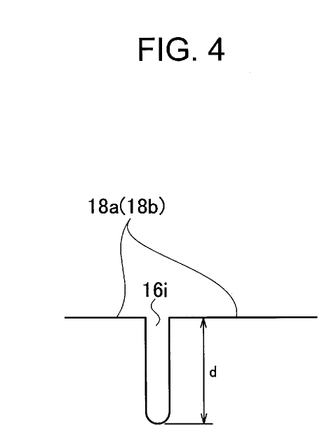

FIG. 1 is a sectional view of a construction vehicle tire of the first embodiment of the present invention in a tire widthwise direction along a tire radial direction. FIG. 2 is an explanatory drawing for explaining the belt structure of the construction vehicle tire of the first embodiment. FIG. 3 is a plan view for explaining a tread pattern in the construction vehicle tire of the first embodiment. In FIG. 3, it is to be noted that separation of the upper side and the lower side of the paper plane is drawn not with break lines but with straight lines for the sake of drawing. FIG. 4 is a sectional view of a first inner widthwise groove formed at a tread portion of the construction vehicle tire of the first embodiment.

As illustrated in FIG. 1, a construction vehicle tire 1 according to the first embodiment is provided with a plurality of belt layers. Specifically, as illustrated in FIGS. 1 and 2, the construction vehicle tire 1 according to the first embodiment is provided with a protective belt layer 11 composed of two protective belts 11A/11B, a main crossing belt layer 12 composed of two main crossing belts 12A/12B, and a small crossing belt layer 13 composed of two small crossing belts 13A/13B in a tread portion 10.

In such a construction vehicle tire 1, the main crossing belt layer 12 is arranged on an outer side in the tire radial direction than the small crossing belt layer 13, and the protective belt layer 11 is arranged on an outer side in the tire radial direction than the main crossing belt layer 12 as illustrated in FIGS. 1 and 2.

In the first embodiment, the angle β (see FIG. 2) formed by a tire circumferential direction U and a cord C constituting the small crossing belt layer 13 is within the range of 4 to 10°. Accordingly, the small crossing belt layer 13 is constituted of a high angle belt having an angle equal to or smaller than 10° between the tire circumferential direction and a cord constituting the belt layer. The angle formed by a cord constituting the main crossing belt layer 12 and the tire circumferential direction U is within the range of 18 to 35°. The angle formed by a cord constituting the protective belt layer 11 and the tire circumferential direction U is within the range of 22 to 33°.

Moreover, as illustrated in FIG. 3, the construction vehicle tire 1 according to the first embodiment is provided with a plurality of block rows defined by a circumferential groove 14 extending in the tire circumferential direction U or a tread end TE, which is an end portion in a tire widthwise direction W of the tread portion 10, and a widthwise groove 16, which extends in the tire widthwise direction W, in the tread portion 10. Here, the circumferential groove 14 extends along the tire circumferential direction and is composed of a circumferential groove 14a located on a tire equator line CL, a circumferential groove 14b located between a center land portion 18a and a second land portion 18b, and a circumferential groove 14c located between the second land portion 18b and a shoulder land portion 18c.

Moreover, the construction vehicle tire 1 according to the first embodiment is constructed in a manner such that a length W2 of the widthwise groove 16 in the tire widthwise direction W becomes equal to or larger than 30% of a tread width W1 (see the definition of the tread width described later), which is the length of the tread portion 10 in the tire widthwise direction W, as illustrated in FIG. 1.

Moreover, in the tread portion 10 on at least one side of the tire equator line CL, the widthwise groove 16 is composed of: a first inner widthwise groove 16i, which opens to the circumferential groove 14c, extends inward in the tire widthwise direction, traverses the second land portion 18b and the center land portion 18a, reaches the tire equator line CL, and opens to the circumferential groove 14a; and a first outer widthwise groove 16e, which is wider than the first inner widthwise groove 16i, opens to the circumferential groove 14c at a position opposed to the first inner widthwise groove 16i in the tire widthwise direction, extends outward in the tire widthwise direction, traverses the shoulder land portion 18c, and traverses the tread end TE. In addition, such widthwise grooves 16 are arrayed in the tire circumferential direction U.

The first inner widthwise groove 16i has an inner widthwise linear groove 16is extending linearly along the tire widthwise direction W from the circumferential groove 14c toward the inner side in the tire widthwise direction. Furthermore, the first inner widthwise groove 16i has a curved groove 16ir, which is continuous with the inner widthwise linear groove 16is, extends inward in the tire widthwise direction and in a tire normal rotation direction R, and reaches the tire equator line CL. The curved groove 16ir forms an inner groove bent portion BD1i together with the inner widthwise linear groove 16is, so that the inner groove bent portion BD1i having a concave shape with respect to the tire normal rotation direction R is formed of the curved groove 16ir and the inner widthwise linear groove 16is.

In addition, an inclination angle θ1, which is an angle formed by the curved groove 16ir and the tire widthwise direction, becomes smaller toward the tire equator line CL. As a result, the first inner widthwise groove 16i is inclined with respect to the tire widthwise direction W so that an inner position in the tire widthwise direction of an area from the tire equator line CL to a high angle belt end HE (which is an end of a belt of the small crossing belt layer 13, that is, an end of a high angle belt in the first embodiment) is grounded earlier during rotation in the tire normal rotation direction R.

Moreover, the end portion of the first outer widthwise groove 16e on the side of the circumferential groove 14c also has a linear shape parallel to the tire widthwise direction W and opens to the circumferential groove 14c. The first inner widthwise groove 16i and the first outer widthwise groove 16e open to the circumferential groove 14c so that the groove wall positions on the tire normal rotation direction R side are aligned.

The first outer widthwise groove 16e has an outer widthwise linear groove 16es extending linearly along the tire widthwise direction W from the circumferential groove 14c toward the outer side in the tire widthwise direction. Furthermore, the first outer widthwise groove 16e has a bent groove 16er, which is continuous with the outer widthwise linear groove 16es, extends in the tire widthwise direction W and toward the tire normal rotation direction R side, is bent so that the inclination angle that is an angle against the tire widthwise direction becomes small, extends outward in the tire widthwise direction with a groove width widened, and reaches the tread end TE. The bent groove 16er forms an outer groove bent portion BD1e together with the outer widthwise linear groove 16es so that the outer groove bent portion BD1e having a concave shape with respect to the tire normal rotation direction R is formed of the bent groove 16er and the outer widthwise linear groove 16es.

Here, the groove bent portion BD1 forming the land part LP1 is composed of the inner groove bent portion BD1i and the outer groove bent portion BD1e.

Moreover, in the shoulder land portion 18c, a second outer widthwise groove 26 is formed at a position spaced from the first outer widthwise groove 16e at a predetermined interval in the tire circumferential direction. The groove width of the second outer widthwise groove 26 is smaller than that of the first outer widthwise groove 16e.

The second outer widthwise groove 26 opens to the circumferential groove 14c and extends along the tire widthwise direction W toward the outer side in the tire widthwise direction. In addition, the second outer widthwise groove 26 has a bent portion 28, which is bent in a crank shape outward in the tire widthwise direction and toward the tire normal rotation direction R side, further extends outward along the tire widthwise direction, and terminates in the shoulder land portion 18c. Here, the term “bent in a crank shape” in this specification includes not only being bent steeply but also being curved gently.

Moreover, between first inner widthwise grooves 16i adjacent to each other in the tire circumferential direction U, a second inner widthwise groove 17i, which has the same shape as the first inner widthwise groove 16i, opens to the circumferential groove 14c, and reaches the tire equator line CL, is arranged. In addition, the opening position J of the second outer widthwise groove 26 to the circumferential groove 14c is a position shifted toward the tire normal rotation direction R side from the opening position K of the second inner widthwise groove 17i to the circumferential groove 14c.

Moreover, in a belt layer B arranged on an inner side in the tire radial direction than the tread portion 10, the small crossing belt layer 13 composed of the two small crossing belts 13A/13B as described above is arranged as a high angle belt.

In addition, in tread surface view, that is, in plan view of the tread portion 10, a connection portion FP in the inner groove bent portion BD1i is arranged in a tire widthwise area S within ⅛, or more preferably a tire widthwise area within 1/16, of the tread width W1 from the high angle belt end HE as the widthwise center.

Here, the tread width is the “tread width” defined by JATMA YEAR BOOK. Moreover, the above-described tread end means the outermost position in the tire widthwise direction of the tire tread surface where the tire surface comes into contact with the ground in a state where the tire is assembled to a normal rim and filled to have normal internal pressure, and a normal load is applied. It is to be noted that “normal rim” means a standard rim specified in the following standard according to the size of the tire, “normal internal pressure” means a pneumatic pressure corresponding to the maximum load capacity of a single wheel in an applicable size described in the following standard, and “normal load” means the maximum load of a single wheel in an applicable size of the following standard, that is, the maximum load capacity. In addition, the standard is an industrial standard effective in an area where the tire is produced or used, for example “JATMA YEAR BOOK” from “Japan Automobile Tyre Manufacturers Association” in Japan, “YEAR BOOK” from “THE TIRE AND RIM ASSOCIATION INC.” in the United States, or “STANDARD MANUAL” from “The European Tyre and Rim Technical Organisation” in Europe.

In addition, in the first embodiment, the maximum value of the angle θ1 formed by the tire widthwise direction W and the curved groove 16ir is set within the range of 20 to 80°. In the first embodiment, it is to be noted that the maximum value of the angle θ1 is an angle at the inner groove bent portion BD1i.

Moreover, the distance L (see FIG. 3) between the first inner widthwise groove 16i and the second inner widthwise groove 17i adjacent to each other in the tire circumferential direction U, and the groove depth d (see FIG. 4) of the first inner widthwise groove 16i along the tire radial direction satisfy the following relational expression.

d/L> 1/10

When focusing on wear resistance property, it is to be noted that the width of the circumferential groove 14 in the tire widthwise direction W is preferably equal to or smaller than 10 mm with which the land portions support each other when force is applied.

On the other hand, when focusing on heat dissipation property, the length width of the circumferential groove 14 in the tire widthwise direction W is preferably larger than 10 mm.

Moreover, from a viewpoint of heat dissipation property, the groove width of the first inner widthwise groove 16i is preferably equal to or larger than 5 mm even at the narrowest part, and the depth of the first inner widthwise groove 16i is preferably equal to or larger than ⅓ of the distance between the tread surface and the belt layer B.

Furthermore, the construction vehicle tire 1 according to the first embodiment may be constructed in a manner such that the circumferential pitch of the first inner widthwise grooves 16i becomes equal to or larger than 50 mm.

(Function, Effect)

The following description will explain the functions and effects of the first embodiment.

In the construction vehicle tire 1 of the first embodiment, the first inner widthwise groove 16i is provided with the inner widthwise linear groove 16is, which opens to the circumferential groove 14c and extends linearly along the tire widthwise direction W toward the inner side in the tire widthwise direction W.

Furthermore, the first inner widthwise groove 16i is provided with the curved groove 16ir, which is continuous with the inner end in the tire widthwise direction of the inner widthwise linear groove 16is, extends inward in the tire widthwise direction and in the tire normal rotation direction R, and reaches the tire equator line CL. In addition, the angle θ1 formed by the curved groove 16ir and the tire widthwise direction W becomes smaller toward the tire equator line. Here, as the angle θ1 becomes larger, the shearing rigidity of the tire tread surface lowers, and therefore the wear resistance performance deteriorates especially during acceleration or deceleration and during turning. Since the angle θ1 becomes larger at a position closer to the connection portion FP and becomes smaller at a position closer to the equator line, the shearing rigidity of the tire tread surface lowers and the braking force of the groove bent portion BD1 becomes largest in the vicinity of the connection portion FP where the angle θ1 is large. Therefore, shearing stress in the tire widthwise area S within ⅛ of the tread width W1 from the high angle belt end HE where a rolling radius becomes large as the widthwise center is suppressed, and uneven wear that is likely to occur in this area is effectively suppressed. In addition, since the block rigidity is maintained in the vicinity of the equator where the angle θ1 is small, a great effect can be obtained from a viewpoint of maintaining the shearing rigidity of the entire tire. Furthermore, since the curved groove 16ir has a curved shape reaching from the connection portion FP to the equator line CL, uniform wear resistance performance in the tire widthwise direction can be obtained on an outer side in the tire widthwise direction than the connection portion FP in comparison with a case where the widthwise groove 16 on an inner side in the tire widthwise direction than the connection portion FP has a groove shape inclined at a certain angle.

Moreover, in tread surface view, the connection portion FP is arranged in the tire widthwise area S within ⅛ of the tread width W1 from the high angle belt end HE as the widthwise center. Therefore, when the tire is rotated in the tire normal rotation direction R during acceleration or the like, force in the tire normal rotation direction R, that is, driving force is generated at the tread rubber part in the vicinity of the high angle belt end HE where the rolling radius is large during tire normal rotation, while the tire rubber is caused to flow in a direction opposite to the tire normal rotation direction R by incompressibility of the tire rubber, and circumferential braking force is generated at a normal rotation side extending land portion LPa defined by the curved groove 16ir and the circumferential grooves 14a, 14b, or a normal rotation side extending land portion LPb defined by the curved groove 16ir and the circumferential grooves 14b, 14c. As a result, this functions as force to suppress the shearing force to be generated against the tread rubber part in the vicinity of the high angle belt end HE where the rolling radius is large during tire normal rotation, that is, to cancel the shearing force when the forces are equal. Accordingly, uneven wear caused by the shearing force due to the driving force and the braking force is suppressed, and therefore the construction vehicle tire 1 with improved uneven wear resistance property can be obtained.

It is to be noted that FIG. 3 illustrates an example in which the position in the tire widthwise direction of the connection portion FP is arranged on a slightly outer side in the tire widthwise direction than the high angle belt end HE, and a remarkable effect in suppressing uneven wear at the ¼ point is achieved. Moreover, the rolling radius can be calculated by measuring the tread surface of the rotating tire with a tread surface observing device or the like.

Moreover, by forming the widthwise groove 16 to have a curved shape as in the first embodiment, it becomes easy to incline only a site, which is desired to be inclined, of the widthwise groove 16 with respect to the tire circumferential direction U, and to secure the rigidity in the tire widthwise direction.

Moreover, the curved groove 16ir configuring the first inner widthwise groove 16i is inclined with respect to the tire widthwise direction so that an inner position in the tire widthwise direction of an area from the tire equator line CL to the high angle belt end HE is grounded earlier during rotation in the tire normal rotation direction R. Therefore, the above-described circumferential braking force can be made large further effectively.

Moreover, the maximum value of the angle θ1 formed by the tire widthwise direction W and the curved groove 16ir is within the range of 20 to 80°. Therefore, the above-described circumferential braking force can be made large more effectively.

Moreover, the first embodiment is constructed in a manner such that the length W2 of the widthwise groove 16 in the tire widthwise direction W becomes equal to or larger than 30% of a length W1 of the tread portion 10 in the tire widthwise direction W. Therefore, by effectively making the above-mentioned circumferential braking force large, it becomes possible to significantly improve the uneven wear resistance property.

Although the first embodiment explains a case where the connection portion FP is arranged in a tire widthwise area within ⅛ of the tread width W1 in tread surface view from the high angle belt end HE as the widthwise center as an example in which the connection portion FP is arranged within a predetermined area in the tire widthwise direction, it is to be noted that the uneven wear resistance property at the tread rubber part can be improved according to a similar principle even when the connection portion FP is arranged in a tire widthwise area within ⅛, or more preferably 1/16, of the tread width W1 not from the high angle belt end HE but from a position in the tire widthwise direction where the rolling radius is large during tire normal rotation as the widthwise center. Furthermore, a similar effect can be achieved even in a construction vehicle tire that does not have a high angle belt.

### Test Example 1

In order to confirm the effect of the present invention, all of prototype tires of Examples 1 to 5 to which the present invention was applied were made at size 59/80R63, and comparison was made regarding uneven wear resistance property. The tires of Examples 1 to 5 were tires having the structure described in the first embodiment, the angle formed by the widthwise groove and the tire widthwise direction at the intersection position of the tire equator line and the widthwise groove was set constant at 10°, the position of the inflection point was set to be constant in the tire widthwise direction, and the maximum value θ of the angle formed by the inner widthwise groove and the tire widthwise direction was respectively set to 15°, 20°, 50°, 80°, and 85°.

In the uneven wear resistance property test, each of the above tires was mounted on a normal rim and filled to have normal internal pressure. Then, each tire was attached to an indoor drum testing machine, loaded with a normal load, and run for 24 hours at a speed of 8 km/h. Then, the amount of uneven wear at the ¼ point of the tread portion of the tire after running was measured

to judge the uneven wear resistance performance. A case where obvious uneven wear was not observed was judged as “good”, while a case where sight uneven wear was observed was judged as “acceptable”.

TABLE 1

| | Example 1 | Example 2 | Example 3 | Example 4 | Example 5 |
|---|---|---|---|---|---|
| MAXIMUM VALUE OF ANGLE θ [°] | 15 | 20 | 50 | 80 | 85 |
| FORMED BY INNER WIDTHWISE GROOVE | | | | | |
| AND TIRE WIDTHWISE DIRECTION | | | | | |
| UNEVEN WEAR | ACCEPTABLE | GOOD | GOOD | GOOD | ACCEPTABLE |
| RESISTANCE | | | | | |

The test results are as illustrated in Table 1. That is, in this test, it was confirmed that the uneven wear resistance performance in Examples 2 to 4 in which the angle θ was set to 20°, 50°, and 80° was better than that of Examples 1 and 5 in which the angle θ was set to 15° and 85°.

### Second Embodiment

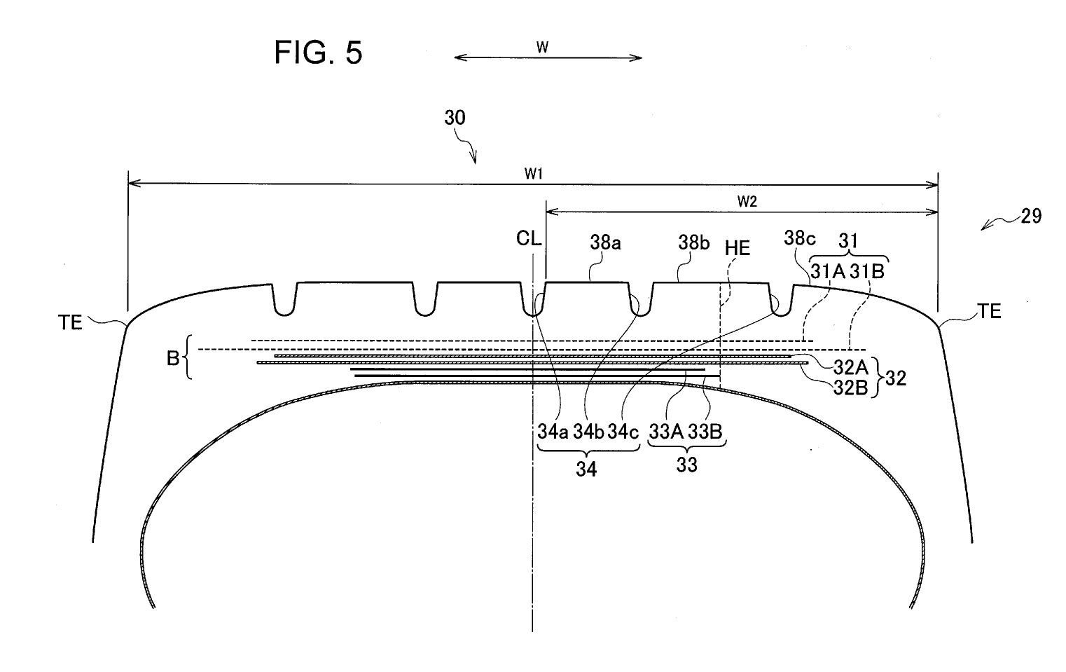

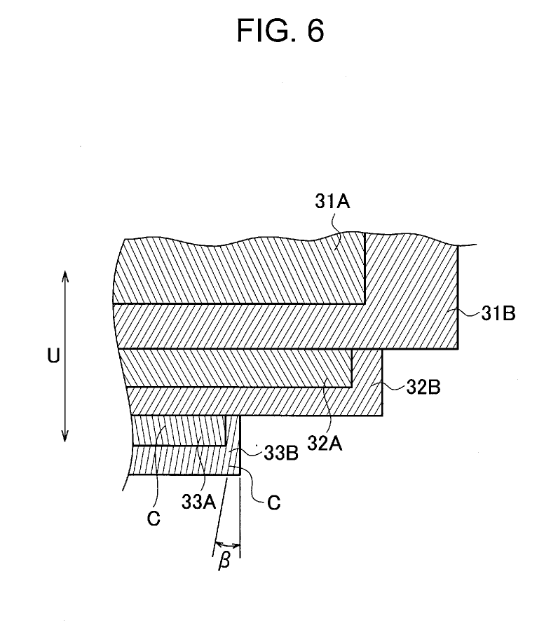

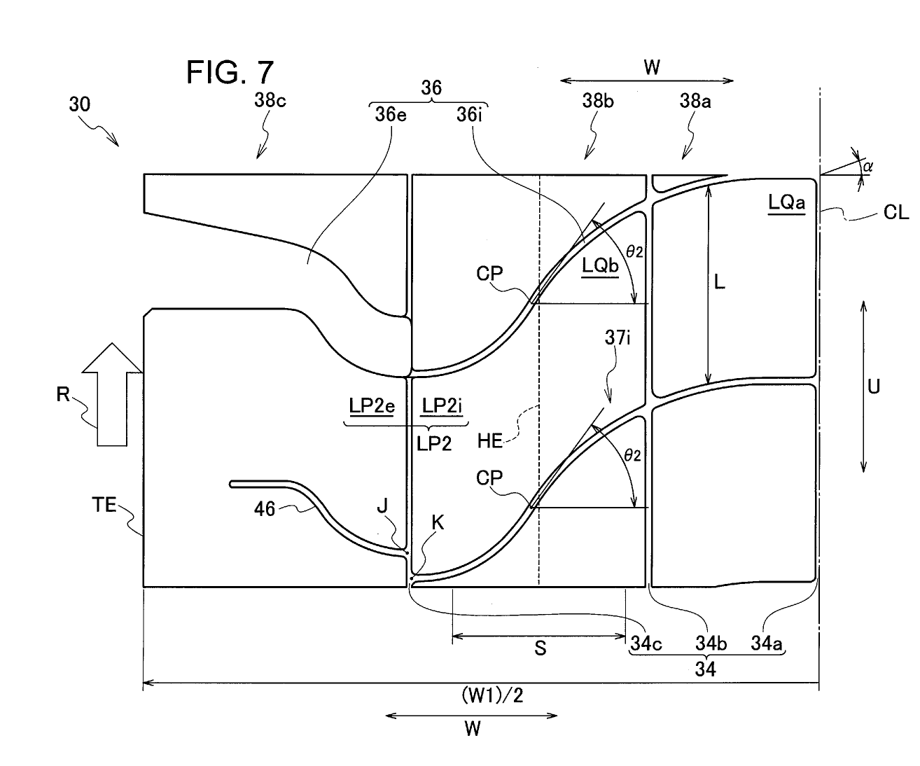

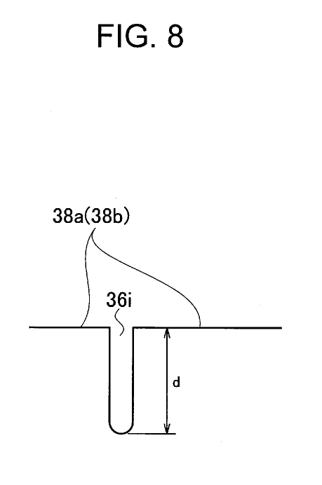

FIG. 5 is a sectional view of a construction vehicle tire according to the second embodiment of the present invention in the tire widthwise direction along a tire radial direction. FIG. 6 is an explanatory drawing for explaining the belt structure of the construction vehicle tire according to the second embodiment. FIG. 7 is a plan view for explaining a tread pattern in the construction vehicle tire according to the second embodiment. In FIG. 7, it is to be noted that separation of the upper side and the lower side of the paper plane is drawn not with break lines but with straight lines for the sake of drawing. FIG. 8 is a sectional view of a first inner widthwise groove formed at a tread portion of the construction vehicle tire according to the second embodiment.

As illustrated in FIG. 5, a construction vehicle tire 29 according to the second embodiment is provided with a plurality of belt layers. Specifically, as illustrated in FIGS. 5 and 6, the construction vehicle tire 29 according to the second embodiment is provided with a protective belt layer 31 composed of two protective belts 31A/31B, a main crossing belt layer 32 composed of two main crossing belts 32A/32B, and a small crossing belt layer 33 composed of two small crossing belts 33A/33B in a tread portion 30.

In such a construction vehicle tire 29, the main crossing belt layer 32 is arranged on an outer side in the tire radial direction than the small crossing belt layer 33, and the protective belt layer 31 is arranged on an outer side in the tire radial direction than the main crossing belt layer 32 as illustrated in FIGS. 5 and 6.

In the second embodiment, the angle β (see FIG. 6) formed by a tire circumferential direction U and a cord C constituting the small crossing belt layer 33 is within the range of 4 to 10°, and therefore the small crossing belt layer 33 is constituted of a high angle belt having an angle equal to or smaller than 10° between the tire circumferential direction and a cord constituting the belt layer. The angle formed by a cord constituting the main crossing belt layer 32 and the tire circumferential direction U is within the range of 18 to 35°. The angle formed by a cord constituting the protective belt layer 31 and the tire circumferential direction U is within the range of 22 to 33°.

Moreover, as illustrated in FIG. 7, the construction vehicle tire 29 according to the second embodiment is provided with a plurality of block rows defined by a circumferential groove 34 extending in the tire circumferential direction U or a tread end TE, which is an end portion in a tire widthwise direction W of the tread portion 30, and a widthwise groove 36, which extends in the tire widthwise direction W, in the tread portion 30. Here, the circumferential groove 34 extends along the tire circumferential direction U and is composed of a circumferential groove 34a located on a tire equator line CL, a circumferential groove 34b located between a center land portion 38a and a second land portion 38b, and a circumferential groove 34c located between the second land portion 38b and a shoulder land portion 38c.

Moreover, in the second embodiment, the widthwise groove 36 is composed of: a first inner widthwise groove 36i, which opens to the circumferential groove 34a, extends outward in the tire widthwise direction, traverses the center land portion 38a and the circumferential groove 34b, traverses the second land portion 38b, and opens to the circumferential groove 34c; and a first outer widthwise groove 36e, which opens to the circumferential groove 34c, traverses the shoulder land portion 38c, and traverses the tread end TE. The groove width of the first outer widthwise groove 36e is larger than that of the first inner widthwise groove 36i.

Moreover, the first inner widthwise groove 36i and the first outer widthwise groove 36e both extend in a curved shape and do not have any corner portion.

Moreover, the construction vehicle tire 29 according to the second embodiment is constructed in a manner such that a length W2 of the widthwise groove 36 in the tire widthwise direction W becomes equal to or larger than 30% of a tread width W1, which is the length of the tread portion 30 in the tire widthwise direction W, as illustrated in FIG. 5.

Moreover, the first inner widthwise groove 36i has an inflection point CP where the direction of a convex or a concave with respect to the tire circumferential direction changes on at least one side of the tire equator line CL.

An inner side of the first inner widthwise groove 36i in the tire widthwise direction than the inflection point CP extends with the angle θ2 against the tire widthwise direction W becoming smaller toward the tire equator line and reaches the tire equator line.

An outer side of the first inner widthwise groove 36i in the tire widthwise direction than the inflection point CP extends toward a side opposite to a tire normal rotation direction R side, that is, toward the tire reversal rotation side and outward in the tire widthwise direction with the angle θ2 against the tire widthwise direction W gradually decreased to 0°, and further extends toward the tire normal rotation direction R side and outward in the tire widthwise direction with the angle against the tire widthwise direction W, which is an acute angle, gradually increased, so that a curved convex shape toward a side opposite to the tire normal rotation direction R, that is, a curved concave shape with respect to the tire normal rotation direction R is obtained. As a result, a curved concave land part LP2 having a curved concave shape with respect to the tire normal rotation direction R is formed.

In the second embodiment, a tire widthwise inner half portion LP2i of the curved concave land part LP2 is defined by the first inner widthwise groove 36i, and a tire widthwise outer half portion LP2e of the curved concave land part LP2 is defined by the first outer widthwise groove 36e.

Moreover, an end portion of the first inner widthwise groove 36i on the side of the circumferential groove 34c opens to the circumferential groove 34c so as to face parallel to the tire widthwise direction W, and an end portion of the first outer widthwise groove 36e on the side of the circumferential groove 34c also opens to the circumferential groove 34c so as to face parallel to the tire widthwise direction W. In addition, the first inner widthwise groove 36i and the first outer widthwise groove 36e open to the circumferential groove 34c so that the groove wall positions on the tire normal rotation direction R side are aligned.

Moreover, in the shoulder land portion 38c, a second outer widthwise groove 46 is formed at a position spaced from the first outer widthwise groove 36e at a predetermined interval in the tire circumferential direction. The groove width of the second outer widthwise groove 46 is smaller than that of the first outer widthwise groove 36e.

The second outer widthwise groove 46 opens to the circumferential groove 34c, extends toward the tire normal rotation direction R side and outward in the tire widthwise direction so as to have a curved convex shape toward a side opposite to the tire reversal rotation direction, that is, a curved concave shape with respect to the tire normal rotation direction R, is further bent outward in the tire widthwise direction, extends linearly along the tire widthwise direction, and terminates in the shoulder land portion 38c.

Moreover, between first inner widthwise grooves 36i adjacent to each other in the tire circumferential direction U, a second inner widthwise groove 17i, which has the same shape as the first inner widthwise groove 36i, opens to the circumferential groove 34c, and reaches the tire equator line CL, is arranged. In addition, the opening position J of the above-described second outer widthwise groove 46 to the circumferential groove 34c is a position shifted toward the tire normal rotation direction R side from the opening position K of the second inner widthwise groove 17i to the circumferential groove 34c.

Moreover, in a belt layer B arranged on an inner side in the tire radial direction than the tread portion 30, the small crossing belt layer 33 composed of the two small crossing belts 33A/33B as described above is arranged as a high angle belt.

In addition, in tread surface view, that is, in plan view of the tread portion 30, an inflection point CP is arranged in a tire widthwise area S within ⅛, or more preferably a tire widthwise area within 1/16, of the tread width W1 from a high angle belt end HE as the widthwise center.

In addition, in the second embodiment, the maximum value of the angle θ2 formed by the tire widthwise direction W and the first inner widthwise groove 36i is set within the range of 20 to 80°. It is to be noted that FIG. 7 illustrates a state where the angle θ2 becomes largest at the inflection point CP.

Furthermore, in the second embodiment, the angle α formed by the first inner widthwise groove 36i and the tire widthwise direction W is within the range of 0 to 20° at the intersection position of the tire equator line CL and the first inner widthwise groove 36i. It is to be noted that FIG. 7 illustrates the first inner widthwise groove 36i in a manner such that α becomes approximately 0°.

Moreover, the distance L (see FIG. 7) between the first inner widthwise groove 36i and the second inner widthwise groove 37i adjacent to each other in the tire circumferential direction U, and the groove depth d (see FIG. 8) of the first inner widthwise groove 36i along the tire radial direction satisfy the following relational expression as in the first embodiment.

d/L> 1/10

When focusing on wear resistance property, it is to be noted that the width of the circumferential groove 34 in the tire widthwise direction W is preferably equal to or smaller than 10 mm with which the land portions support each other when force is applied.

On the other hand, when focusing on heat dissipation property, the width of the circumferential groove 34 in the tire widthwise direction W is preferably larger than 10 mm.

Furthermore, the construction vehicle tire 29 according to the second embodiment may be constructed in a manner such that the circumferential pitch of the first inner widthwise grooves 36i becomes equal to or larger than 50 mm.

(Function, Effect)

The following description will explain the functions and effects of the second embodiment.

In the construction vehicle tire 29 of the second embodiment, the widthwise groove 36 composed of the first inner widthwise groove 36i and the first outer widthwise groove 36e opens to the circumferential groove 34a and has an inflection point CP where the direction of a convex or concave with respect to the tire circumferential direction U changes toward the outer side in the tire widthwise direction.

In addition, an inner side of the widthwise groove 36 in the tire widthwise direction than the inflection point CP extends with the angle θ2 against the tire widthwise direction W becoming smaller toward the tire equator line and reaches the tire equator line. Here, as the angle θ2 becomes larger, the shearing rigidity of the tire tread surface lowers, and therefore the wear resistance performance deteriorates especially during acceleration or deceleration and during turning. Since the angle θ2 becomes larger at a position closer to the inflection point CP and becomes smaller at a position closer to the equator line, the shearing rigidity of the tire tread surface lowers and therefore the braking force of the curved concave land part LP2 becomes largest in the vicinity of the inflection point CP where the angle θ2 is large. Therefore, shearing stress in the tire widthwise area S within ⅛ of the tread width W1 from the high angle belt end HE where a rolling radius becomes large as the widthwise center is suppressed, and uneven wear that is likely to occur in this area is effectively suppressed. In addition, since the block rigidity is maintained in the vicinity of the equator where the angle θ2 is small, a great effect can be obtained from a viewpoint of maintaining the shearing rigidity of the entire tire. Furthermore, since the widthwise groove 36 has a curved shape reaching from the inflection point CP to the equator line CL, uniform wear resistance performance in the tire widthwise direction can be obtained on an outer side in the tire widthwise direction than the inflection point CP in comparison with a case where the widthwise groove 36 on an inner side in the tire widthwise direction than the inflection point CP has a groove shape inclined at a certain angle.

In addition, an outer side of the widthwise groove 36 in the tire widthwise direction than the inflection point CP extends from the inflection point CP toward the tire reversal rotation direction side, that is, a side opposite to the tire normal rotation direction R side and outward in the tire widthwise direction and further extends toward the tire normal rotation direction R side and outward in the tire widthwise direction, so that a curved concave land part LP2 having a curved concave shape with respect to the tire normal rotation direction R is formed. In addition, in tread surface view, the inflection point CP is arranged in a tire widthwise area within ⅛ of the tread width W1 from the high angle belt end HE as the widthwise center.

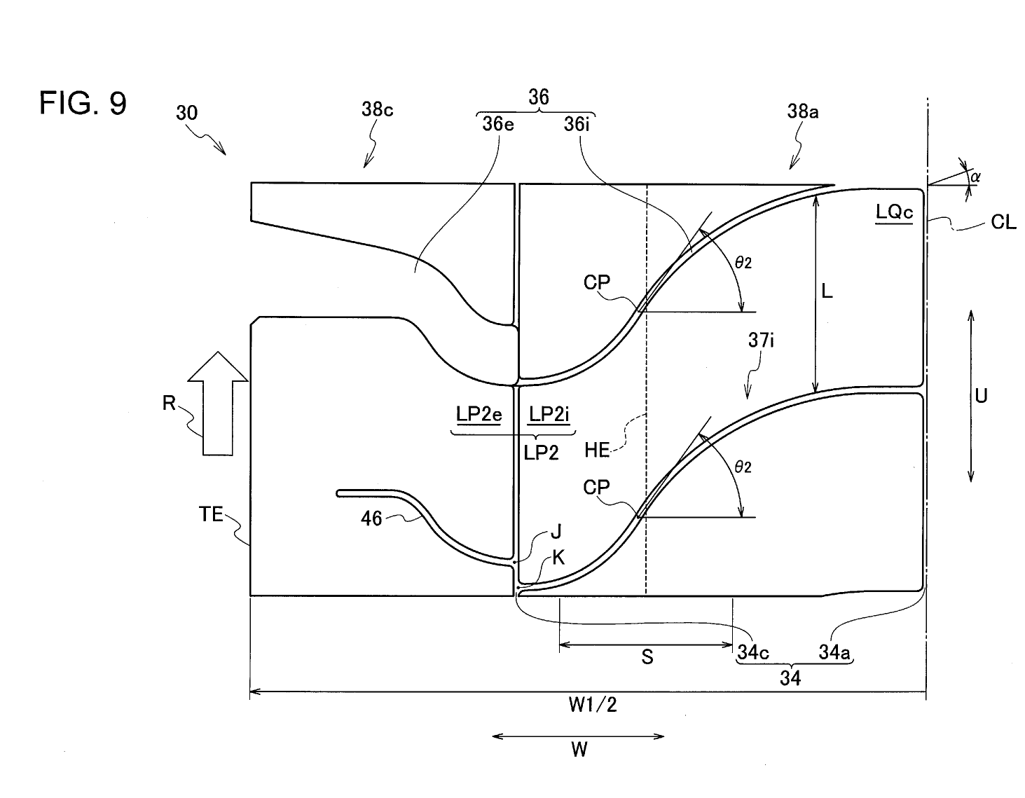

Therefore, when the tire is rotated in the tire normal rotation direction R during acceleration or the like, force in the tire normal rotation direction R, that is, driving force is generated at the tread rubber part in the vicinity of the high angle belt end HE where the rolling radius is large during tire normal rotation, while the tire rubber is caused to flow in a direction opposite to the tire normal rotational direction R by incompressibility of the tire rubber, and circumferential braking force is generated at a normal rotation side extending land portion LQa defined by the first inner widthwise groove 36i and the circumferential grooves 34a, 34b, or a normal rotation side extending land portion LQb defined by the first inner widthwise groove 36i and the circumferential grooves 34b, 34c. As a result, this functions as force to suppress the shearing force to be generated against the tread rubber part in the vicinity of the high angle belt end HE where the rolling radius is large during tire normal rotation, that is, to cancel the shearing force when the forces are equal. Accordingly, uneven wear caused by the shearing force due to the driving force and the braking force is suppressed, and therefore the construction vehicle tire 29 with improved uneven wear resistance property can be obtained. As illustrated in FIG. 9, it is to be noted that it is also possible to adopt a structure in which the circumferential groove 34b is not formed. With such a structure, it is possible to obtain a further remarkable effect in the forward rotation side extending land portion LQc defined by the first inner widthwise groove 36i and the circumferential grooves 34a, 34c.

It is to be noted that FIG. 7 illustrates an example in which the position in the tire widthwise direction of the inflection point CP is arranged on a slightly outer side in the tire widthwise direction than the high angle belt end HE, and a remarkable effect in suppressing uneven wear at the ¼ point is achieved.

Moreover, by forming the widthwise groove 36 to have a curved shape as in the second embodiment, it becomes possible to incline only a site, which is desired to be inclined, of the widthwise groove 36 with respect to the tire circumferential direction U, and it becomes easy to ensure the rigidity in the tire widthwise direction. Moreover, since the inclination of the widthwise groove 36 can be made large in comparison with a case where the widthwise groove 36 has a corner portion, the above-described circumferential breaking force can be made large effectively.

Moreover, the first inner widthwise groove 36i is inclined with respect to the tire widthwise direction so that an inner position in the tire widthwise direction of an area from the tire equator line CL to the high angle belt end HE is grounded earlier during rotation in the tire normal rotation direction R. Therefore, the above-described circumferential braking force can be made large further effectively.

Moreover, the maximum value of the angle θ2 formed by the tire widthwise direction W and the first inner widthwise groove 36i is within the range of 20 to 80°. Therefore, the above-described circumferential braking force can be made large more effectively.

Moreover, the second embodiment is constructed in a manner such that the length W2 of the widthwise groove 36 in the tire widthwise direction W becomes equal to or larger than 30% of a length W1 of the tread portion 30 in the tire widthwise direction W. Therefore, by effectively making the above-mentioned circumferential braking force large, it becomes possible to significantly improve the uneven wear resistance property.

Moreover, the angle α formed by the first inner widthwise groove 36i and the tire widthwise direction W is within the range of 0 to 20° at an intersection position of the tire equator line CL and the first inner widthwise groove 36i. This effectively prevents the block rigidity from being impaired.

Although the second embodiment explains a case where the inflection point CP is arranged in a tire widthwise area within ⅛ of the tread width W1 in tread surface view from the high angle belt end HE as the widthwise center as an example in which the inflection point CP is arranged within a predetermined area in the tire widthwise direction, it is to be noted that the uneven wear resistance property at the tread rubber part can be improved according to a similar principle even when the inflection point CP is arranged in a tire widthwise area within ⅛, or more preferably 1/16, of the tread width W1 not from the high angle belt end HE but from a position in the tire widthwise direction where the rolling radius is large during tire normal rotation as the widthwise center. Furthermore, even a construction vehicle tire not having a high angle belt can achieve a similar effect, and a similar effect can also be achieved with not a construction vehicle tire but a heavy load tire.

### Test Example 2

In order to confirm the effect of the present invention, all of prototype tires of the examples to which the present invention was applied were made at size 59/80R63, and comparison was made regarding block rigidity and uneven wear resistance property. The tires of Examples 6 to 9 were tires having the structure described in the second embodiment, the maximum value of the angle θ formed by the inner widthwise groove and the tire widthwise direction was set constant at 50°, the position of the inflection point was set to be constant in the tire widthwise direction, and the angle α formed by the widthwise groove and the tire widthwise direction at the intersection position of the tire equator line and the widthwise groove was respectively set to 0°, 10°, 20°, and 25°.

In the block rigidity test, the base of the block was fixed, constant shearing force (the direction was the tire circumferential direction) was applied to the tread surface of the block, and the displacement amount of the tread surface of the block was measured. The test was carried out on the tires of Examples 6 to 9. Evaluation is shown using indexes with respect to the reciprocal of the displacement amount of Example 6 with the angle α set at 0° shown as 100, and a larger numerical value indicates that the displacement amount is smaller and the block rigidity is higher. Regarding uneven wear resistance property, an uneven wear resistance property test similar to Example 1 was carried out on the tires of Examples 6 to 9 and evaluation was made.

TABLE 2

| | Example 6 | Example 7 | Example 8 | Example 9 |
|---|---|---|---|---|
| MAXIMUM VALUE OF ANGLE θ [°] | 0 | 10 | 20 | 25 |
| FORMED BY INNER WIDTHWISE GROOVE | | | | |
| AND TIRE WIDTHWISE DIRECTION | | | | |
| BLOCK RIGIDITY | 100 | 99 | 99 | 96 |
| UNEVEN WEAR | GOOD | GOOD | GOOD | ACCEPTABLE |
| RESISTANCE | | | | |

The test results are as described in Table 2. That is, in Example 9 in which the angle α was set to 25°, the index of block rigidity lowered to 96, and accordingly, the uneven wear resistance property lowered in comparison with Examples 7 and 8 in which the evaluation index of block rigidity was 99. On the other hand, in Examples 7 and 8 in which the value of the evaluation index of block rigidity was 99, no lowering in the uneven wear resistance property in comparison with Example 6 was confirmed.

This application claims priority based on Japanese Patent Application No. 2016-106223 filed on May 27, 2016, and the entire contents thereof are herein incorporated by reference.

### INDUSTRIAL APPLICABILITY

The heavy load tire according to the embodiments of the present invention improves uneven wear resistance property by suppressing shearing force to be generated between a tread rubber part where driving force is generated and a tread rubber part adjacent to the above-described tread rubber part where braking force is generated.

### REFERENCE SIGNS LIST

1 CONSTRUCTION VEHICLE TIRE
10 TREAD PORTION
13 SMALL CROSSING BELT LAYER (HIGH ANGLE BELT)
14 CIRCUMFERENTIAL GROOVE
14a CIRCUMFERENTIAL GROOVE
14b CIRCUMFERENTIAL GROOVE
14c CIRCUMFERENTIAL GROOVE
16 WIDTHWISE GROOVE
16e FIRST OUTER WIDTHWISE GROOVE
16i FIRST INNER WIDTHWISE GROOVE
16is INNER WIDTHWISE LINEAR GROOVE
16ir CURVED GROOVE
17i SECOND INNER WIDTHWISE GROOVE
26 SECOND OUTER WIDTHWISE GROOVE
29 CONSTRUCTION VEHICLE TIRE
30 TREAD PORTION
33 SMALL CROSSING BELT LAYER (HIGH ANGLE BELT)
34 CIRCUMFERENTIAL GROOVE
34a CIRCUMFERENTIAL GROOVE
34b CIRCUMFERENTIAL GROOVE
34c CIRCUMFERENTIAL GROOVE
36 WIDTHWISE GROOVE
37i SECOND INNER WIDTHWISE GROOVE
46 SECOND OUTER WIDTHWISE GROOVE
B BELT LAYER
BD1 GROOVE BENT PORTION
CL TIRE EQUATOR LINE
CP INFLECTION POINT
FP CONNECTION PORTION
HE HIGH ANGLE BELT END
LP1 LAND PART
LP2 CURVED CONCAVE LAND PART
TE TREAD END
R TIRE NORMAL ROTATION DIRECTION
U TIRE CIRCUMFERENTIAL DIRECTION
W TIRE WIDTHWISE DIRECTION
W1 TREAD WIDTH
θ1 ANGLE
θ2 ANGLE
α ANGLE

1. A heavy load tire comprising a tread portion, wherein
the tread portion is partitioned into a plurality of portions by a widthwise groove extending in a tire widthwise direction, and at least one of a circumferential groove extending in a tire circumferential direction and a tread end that is an end portion of the tread portion,
the circumferential groove and a first inner widthwise groove, which is arrayed in a tire circumferential direction and included in the widthwise groove, are formed on at least one side of a tire equator line,
the first inner widthwise groove opens to the circumferential groove, extends inward in the tire widthwise direction, and reaches the tire equator line,
the first inner widthwise groove includes:
an inner widthwise linear groove extending linearly along a tire widthwise direction from the circumferential groove toward an inner side in the tire widthwise direction; and
a curved groove, which is continuous with an inner end in the tire widthwise direction of the inner widthwise linear groove, extends inward in the tire widthwise direction and in a tire normal rotation direction, and reaches the tire equator line, and
an angle formed by the curved groove and the tire widthwise direction becomes smaller toward the tire equator line.

2. The heavy load tire according to claim 1, wherein a connection portion of the inner widthwise linear groove and the curved groove is arranged within a predetermined area in the tire widthwise direction.

3. The heavy load tire according to claim 2, wherein
a high angle belt is arranged in a belt layer arranged on an inner side in the tire radial direction than the tread portion, and
the connection portion is arranged in a tire widthwise area within ⅛ of a tread width from a high angle belt end as a widthwise center in tread surface view.

4. The heavy load tire according to claim 1, wherein a first outer widthwise groove, which is included in the widthwise groove, is wider than the first inner widthwise groove, opens to the circumferential groove at a position opposed to the first inner widthwise groove, and extends outward in the tire widthwise direction, is arrayed in the tire circumferential direction.

5. The heavy load tire according to claim 4, wherein a second outer widthwise groove, which is narrower than the first outer widthwise groove, opens to the circumferential groove, and extends outward in the tire widthwise direction, is arranged between the first outer widthwise grooves adjacent to each other in the tire circumferential direction.

6. The heavy load tire according to claim 5, wherein
a second inner widthwise groove, which has a same shape as the first inner widthwise groove, opens to the circumferential groove, and reaches the tire equator line, is arranged between first inner widthwise grooves adjacent to each other in the tire circumferential direction, and
an opening position of the second outer widthwise groove to the circumferential groove is set to a position shifted in the tire circumferential direction from an opening position of the second inner widthwise groove to the circumferential groove.

7. The heavy load tire according to claim 1, wherein a maximum value of an angle formed by the widthwise groove and the tire widthwise direction is within a range of 20 to 80°.

8. A heavy load tire comprising a tread portion, wherein
the tread portion is partitioned into a plurality of portions by a widthwise groove extending in a tire widthwise direction, and at least one of a circumferential groove extending in a tire circumferential direction and a tread end that is an end portion of the tread portion,
the widthwise groove has an inflection point where a direction of a convex or a concave with respect to the tire circumferential direction changes on at least one side of a tire equator line,
the widthwise groove extends with an angle against the tire widthwise direction becoming smaller toward the tire equator line and reaches the tire equator line on an inner side in the tire widthwise direction than the inflection point, and
the widthwise groove extends toward a side opposite to a tire normal rotation direction and outward in the tire widthwise direction and further extends in the tire normal rotation direction and outward in the tire widthwise direction on an outer side in the tire widthwise direction than the inflection point so as to have a curved convex shape toward a side opposite to the tire normal rotation direction.

9. The heavy load tire according to claim 8, wherein the inflection point is arranged within a predetermined area in the tire widthwise direction.

10. The heavy load tire according to claim 9, wherein
a high angle belt is arranged in a belt layer arranged on an inner side in the tire radial direction than the tread portion, and
the inflection point is arranged in a tire widthwise area within ⅛ of a tread width from a high angle belt end as a widthwise center in tread surface view.

11. The heavy load tire according to claim 8, wherein an angle formed by the widthwise groove and a tire widthwise direction is within a range of 0 to 20° at an intersection position of the tire equator line and the widthwise groove.

12. The heavy load tire according to claim 8, wherein a maximum value of an angle formed by the widthwise groove and the tire widthwise direction is within a range of 20 to 80°.
